(19) United States
(12) Patent Application Publication
(10) Pub. No.: US 2015/0356477 A1
(43) Pub. Date: Dec. 10, 2015

(54) METHOD AND SYSTEM FOR TECHNOLOGY RISK AND CONTROL

(71) Applicant: The Toronto-Dominion Bank, Toronto (CA)

(72) Inventors: Paul MILKMAN, Toronto (CA); Gerry Owens, Courtice (CA); Janice McMullen, Pickering (CA); Frank Coletti, Dorchester (CA); Andrew Vesay, Flemington, NJ (US); Warren Chin Yee, Markham (CA)

(21) Appl. No.: 14/300,037

(22) Filed: Jun. 9, 2014

(51) Int. Cl. G06Q 10/06

(52) U.S. Cl. CPC G06Q 10/0635; G06Q 10/0633

(57) ABSTRACT

A computer-implemented method and system provides a collaborative framework to assess and manage an enterprise's technology risk and controls for mitigating such risk. The framework is configured to collect risk assessments associated with technology assets from various lines of business within an enterprise, map such risks to appropriate controls and identify and manage control gaps were controls are not in place. The system may comprise a database and a framework application providing access to the database. The framework application is enabled with workflow, such as via rules, to assign tasks to collaborative users and track task completion. Various risk data, control data and workflow-related task data may be stored to the database. Various data views and reports may be generated for identifying tasks for completion, assessing performance and compliance. The rules may be configurable to alter the workflow.

### FIELD

The disclosed embodiments generally relate to computer systems and methods for managing technology risk and information security, and more particularly to computer implemented methods and systems for technology risk and control management.

### BACKGROUND

Large financial institutions and other organizations increasingly rely on technological solutions including a plurality of business applications and/or infrastructure to provide their respective products and services as well as to manage their internal operations. Regulatory and other compliance demands are also assisted by technological solutions. Each application or other asset poses risks for various undesirable outcomes and requires appropriate controls that are acceptable to the business and their technology partners.

The business environment is rarely static. Changes or new technological solutions are often adopted to address business needs and regulatory demands. Technology risk must be assessed and reassessed accordingly such that risk and control management requirements are iterative and ongoing.

A large institution may have thousands of applications and other assets across a plurality of business lines. Managing the technology risk effectively and efficiently can be daunting.

### SUMMARY

A computer-implemented method and system provides a collaborative framework to assess and manage an enterprise's technology risk and controls for mitigating such risk. The framework is configured to collect risk assessments associated with technology assets from various lines of business within an enterprise, map such risks to appropriate controls and identify and manage control gaps were controls are not in place. The system may comprise a database and a framework application providing access to the database. The framework application is enabled with workflow, such as via rules, to assign tasks to collaborative users and track task completion. Various risk data, control data and workflow-related task data may be stored to the database. Various data views and reports may be generated for identifying tasks for completion, assessing performance and compliance. The rules may be configurable to alter the workflow.

There is disclosed a computer for collaborative technology risk management comprising: a database to store technology risk and control data for a plurality of business assets utilized by an enterprise; and a processor and memory storing instructions for configuring operations of the computer to provide: user interfaces to store and access the technology risk and control data; and workflow for collaboratively performing tasks by a plurality of collaborating users to perform the technology risk management; and wherein the workflow and user interfaces are configured to: assess business asset risk for a particular business asset; perform control design to identify controls for the particular business asset in response to the business asset risk; and indentify and manage control gaps where controls for the particular business asset are not in place.

The computer may be a part of a computer system with a plurality of user computers in communication to perform the collaborative technology risk management. The computer may be communicatively linked to an additional computer such as one configured to maintain asset records (e.g. in an application book of record) with details concerning applications. The computer and additional computer may communicate to trigger the collaborative technology risk management such as for a new asset.

There is disclosed a computer-implemented method to collaboratively perform technology risk management comprising: storing and providing access to technology risk and control data via user interfaces to a computer, the technology risk and control data maintained in a database communicatively coupled to the computer and the technology risk and control data providing information for a plurality of business assets utilized by an enterprise; and providing workflow for collaboratively performing tasks by a plurality of collaborating users to complete the technology risk management; and wherein the workflow and user interfaces are configured to; assess business asset risk for a particular business asset; perform control design to identify controls for the particular business asset in response to the business asset risk; and indentify and manage control gaps where controls for the particular business asset are not in place

### BRIEF DESCRIPTION OF THE DRAWINGS

FIGS. 1A and 1B are block diagrams which illustrate an overview of the technology risk and control process.

FIGS. 2A and 2B are tabular illustrations of respective risk and control matrices in accordance with examples.

FIG. 3 is a block diagram which illustrates a high level system context 300 implementing the framework and including interfaces and/or data shared among various actors who interact with the framework in accordance with an example.

FIG. 4 is a block diagram which illustrates a representative computing environment for the framework in accordance with an example.

FIG. 5 is a block diagram of an overview of workflow including documents/data generated in accordance with an example.

FIGS. 6A and 6B are flowcharts of workflow operations in more detail and in accordance with an example.

### DETAILED DESCRIPTION

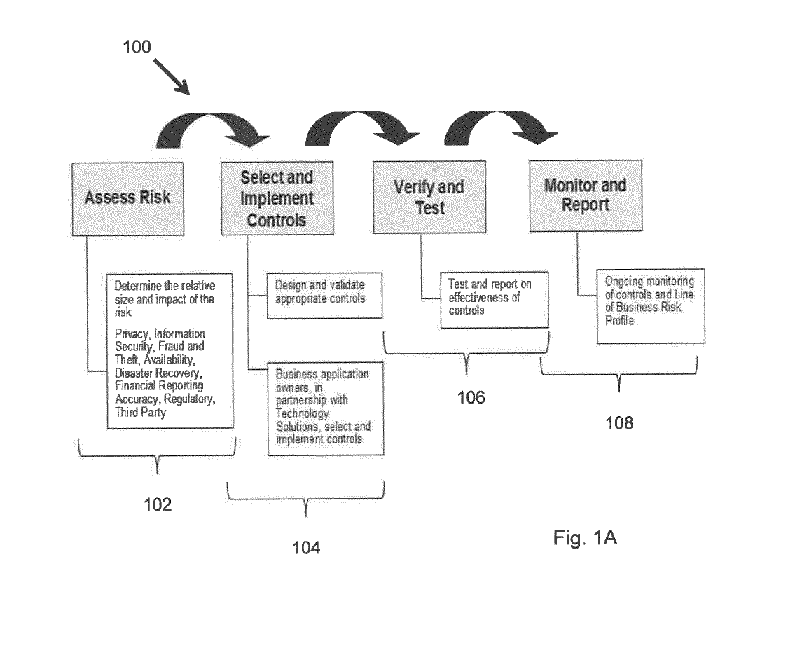

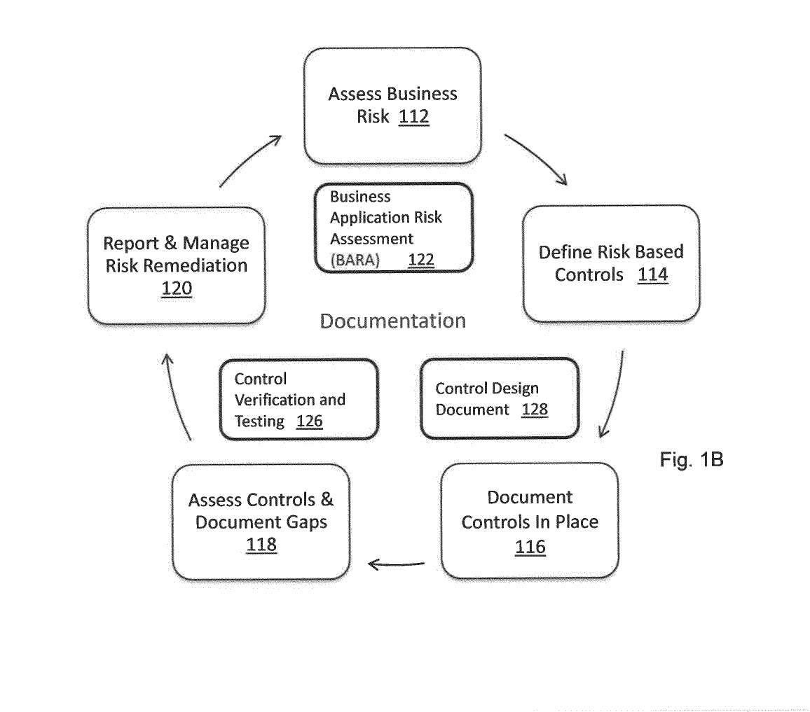

FIGS. 1A and 1B illustrate an overview of the technology risk and control process. In some embodiments, the process may be adapted for non-technology assets.

FIG. 1A illustrates an enterprise technology risk and control framework 100, in accordance with disclosed embodiments. For example, framework 100 may provide a common structure for organizing risk and control information and a structured process for managing risk and controls. In some aspects, a control may include an activity implemented to meet a control requirement, such as a testable function associated with an asset. In other aspects, a control requirement may be a governance level statement of a risk management objective that must be met. Controls may be categorized such as a Key Control—a control that if not met will result in risk exposure outside of established risk tolerance. Control requirements may be categorized such as a Baseline Key Control Requirement—a control requirement driven from the control framework based on assessed risk that drives a key control. Risk may be considered as an event that carries the potential to negatively impact an asset. Risk may be categorized such as Inherent Risk—a business assessed risk exposure prior to controls being applied and Residual Risk—remaining business risk exposure after controls have been applied.

In step 102, the inherent risk of a technology asset is accessed. The relative size and impact of risk in a plurality (eight) of categories is determined. Risk assessment and the risk categories are discussed further below. An asset in this document may refer to something that is of value to the business such as an application, service, or data as part of the overall information systems. An asset is thus a generic classifier. An asset may represent: applications, services, software, platforms, stacks, data stores, hardware, or appliances (e.g. tightly coupled hardware and software where one can't be distinguished from the other), business process, intellectual property, facility etc. An application may refer to a business name or label that associates a collection of technical components (software, business services, databases) in support of a business process for the purposes of facilitating management (e.g. defining accountabilities, billing, business and technology ownership, Technology Supporting group, etc.).

In step 102, the framework prescribes the relevant control requirements for mitigating the risks. Particular controls for the risks are selected and implemented. The controls may be selected and implemented in a collaborative manner between the owners of the asset (from the applicable line of business) and the technology solutions providers to determine commensurate controls that are appropriate in the circumstances.

At step 104, the controls are verified and tested. Effectiveness may be measured and reports generated.

At step 106, the risk and the controls are monitored in an ongoing basis and reports generated.

Technology Risk Appetite (tolerance) may be measured as a ratio of Inherent to Residual Risk for an application (technology asset). Control gap reporting may be based on self-identified issues and can be reviewed and validated over an 18 to 24 month period, for example, to arrive at a representation of risk. Risk appetite thresholds may be set as a baseline and monitored and adjusted (e.g. over the period) to refine the process.

State of Control may be calculated as a ratio of Inherent to Residual risk at the application level. Calculations for Inherent and Residual risk may be implemented within Control Design templates. Application totals (for applicable controls/risk) may be rolled up to enterprise and line of business levels to produce periodic (e.g. monthly) Key Risk Indicators (KRI).

FIG. 1B illustrates the framework as a cyclic process 110, wherein business risk is assessed (step 112), risk based controls are defined (step 114), controls in place are documented (step 116), controls are assessed and any gaps are documented (step 118) and risk mediation is managed and reported (step 120). The various phases or steps of the process may produce documentation such as a business application risk assessment (SARA) 122, a control design document 128 and a control verification and testing report 126.

The Technology Risk and Control Framework supports several business processes:

Managing the control framework;

Assessing business risk associated with technology (risk assessment);

Determining appropriate control standards applicable based on risk assessment (control design);

Identifying, documenting and tracking remediation of control gaps; and

Verifying control effectiveness through process maturity reviews and control testing.

A line of business or another party on its behalf (such as an IT management group within the enterprise) may maintain an application inventory system for managing their business applications and assets. The steps of the risk and control framework 100 for a particular business application or asset may be initiated or triggered for various reasons or events. The triggers may comprise, a risk and control self assessment initiative, a new business initiative, a procurement or outsourcing event, systems development lifecycle (SCLC), modification to the BARA methodology (e.g., new risk category), industry regulations, and/or security incidents and events, etc. As described in more detail below, various personnel such as representatives from the line of business and technology risk and assessment team members undertake the assessment such as via one or more automated questionnaires to produce BARA documentation for storing to a database.

In some embodiments, business application risk assessment is intended to aid in the understanding and documentation of business risks attributed to a technology asset (e.g. an application). This assessment may be focused on inherent risk. The framework may seek to understand the inherent risks of a technology asset and prescribe the relevant control requirements for mitigating these risks. The assessments performed in the BARA may be configured to report inherent risk, without the considerations of any controls already in place or the likelihood/probability that the risk will be realized.

As noted with respect to step 102, inherent risks may be identified across a plurality of risk categories. Eight risk categories are listed and defined in Table 1:

TABLE 1
Risk Categories

| Risk Category | Business Risk Statement |
|---|---|
| Confidentiality: | Risk of the loss of, and/or the risk of the unauthorized |
| Privacy | collection, use, disclosure, storage, delivery, disposal, |
| | handling, access, transmission, or transfer of personal |
| | information. |
| Confidentiality: | Risk of loss due to unintentional disclosure of informa- |
| Information | tion to those not authorized to have access. |
| Security | |
| Fraud/Theft | Risk of loss impacting the enterprise's reputation, |
| | financials, customers and/or business opportunities |
| | due to Fraud or Theft |
| Availability | Risk of loss impacting the enterprise's reputation, |
| | financials, customers and/or business opportunities |
| | due to unplanned outages. |
| 3rd Party | Risk of loss impacting the enterprise's earnings, |
| Management | capital, operations and reputation customers and/or |
| | business opportunities due to a 3rd Party's inability |
| | to properly manage, oversee and deliver the products |
| | or services as defined by the contract. |
| Disaster | Risk of an enterprise loss of technology processing |
| | or services impacting all or most of the enterprise's |
| | business lines. |
| Data | Risk of undetected errors or inaccuracies as a result |
| Integrity/ | of ineffective controls over data at rest, in-transit |
| Reporting | or in-processing, affecting the data quality/accuracy |
| Accuracy | that will lead to a material misstatement (including |
| | financial reporting) or regulatory reporting errors. |
| Regulatory | Risk of regulatory action and reputational damage |
| Compliance | due to non-compliance with applicable regulations, |
| | industry specific rules, guidelines, standards and |
| | commitments. |

The impact or severity of each risk may be quantified by the business owners and/or framework team members against an impact scale such as: insignificant, minor, moderate, major and extensive that provides additional granularity to a low/medium/high scale. Consultation with IT service providers may be undertaken as well when assessing risk. Other qualitative or quantitative scales may be adopted or already exist within areas of the enterprise to measure risk (not shown). The various scales may be aligned with a consolidated impact sale. In the present example each risk category is assessed using a single scale for consistency.

By removing probability out of the risk equation the determination of risk may be simplified to an impact sizing exercise. Risk assessment is described below with reference to the disaster and data integrity/reporting accuracy risk categories.

Disaster

Risk Statement—Risk of an enterprise loss of technology processing or services impacting all or most of the enterprise's business lines.

Definition: —A disaster is an uncontrollable event that impacts in part or in total the technological infrastructure located at a primary data centre for a sustained or indefinite period of time.

Guidance for each severity level for the disaster risk category is defined Table 2 below:

TABLE 2
Disaster risk category severity level

| | |
|---|---|
| Extensive | An Extensive rated application for Disaster would have |
| | some or all of the following characteristics: |
| | Recovery of the application required within 6 hours. |
| | Tolerable data loss of less than ½ hour. |
| | Application Recovery Service levels during the event |
| | would need to equal those of production. |
| | Immediate or imminently serious consequences |
| | Extensive and visible service impact to many customers. |
| | Severe and extended disruptions to critical business |
| | systems and operations. |
| | Media attention from major or multiple outlets causing |
| | massive negative impact to brand or reputation is |
| | anticipated or exists. |
| Major | A Major rated application for Disaster would have some |
| | or all of the following characteristics: |
| | Recovery of the application required within 6 hours. |
| | Tolerable data loss of less than ½ hour up to 24 |
| | hours, most likely ½ hour or less. |
| | Application Recovery Service levels during the event |
| | would need to equal those of production.) |
| | Severe internal user impact. |
| | Significant and serious levels of system/service |
| | disruptions and visibility or number of external |
| | customers impacted is large/growing. |
| | Reduced service level under contingency mode is |
| | expected to worsen. |
| | Media attention from major or multiple outlets |
| | anticipated/exists. |
| Moderate | A Moderate rated application for Disaster would have |
| | some or all of the following characteristics: |
| | Recovery of the application required within 72 hours |
| | Tolerable data loss of greater than ½ hour, but less |
| | than 24 hours. |
| | Application Recovery Service levels during the event |
| | would not need to equal those of production. |
| | Moderate & Transitional (Days) |
| | Limited internal user impact. |
| | Degraded operations and service levels but still |
| | processing or providing service. |
| | Able to maintain reasonably normal levels of external |
| | customer services |
| | Regional Media attention may exist. |
| Minor | A Minor rated application for Disaster would have some |
| | or all of the following characteristics: |
| | Application DR may not be required at this level of |
| | risk. |
| | Less than 24 hours of data loss is acceptable. |
| | Minimal/Low (Wks/Mths) |
| | Minor internal user impact |
| | Experiencing sporadic/isolated problems with limited |
| | number of impacted users. |
| | Able to maintain acceptable levels of service and |
| | systems/operations are expected to remain stable. |
| | Local media attention may exist. |
| Insignificant | An Insignificant rated application for Disaster would |
| | have some or all of the following characteristics: |
| | Application DR would likely not be in scope for this |
| | level of risk. |
| | Less than 24 hours of data loss is acceptable. |

A portion of a Disaster risk category BARA questionnaire with guidance for the severity levels is shown below in Table 3:

TABLE 3
Disaster BARA questionnaire

Is there an impact to the enterprise should a catastrophic datacenter
disaster render this asset unavailable for an extended period of time?
Is the recovery of the application from a loss of its primary processing
facility needed?
If ‘Yes’ continue to rate the disaster risk and identify the risk
attributes
If ‘No’ Disaster risk may be rated as Insignificant
Is there an impact to the enterprise should a catastrophic datacenter
disaster render this asset unavailable for an extended period of time?
A loss of a primary computing facility supporting your
applications would result in business impacts decribed below:
General Guidance
Business can tolerate the loss of the application for a duration of:
0-6 hours
6-72 hours
Indefinitely
Business can tolerate a loss of data:
less than ½ hour loss of data
less than 24 hours loss of data
complete loss of data

Data Integrity/Reporting Accuracy

Risk Statement—Risk of undetected errors or inaccuracies as a result of ineffective controls over data at rest, in-transit or in-processing, affecting the data quality/accuracy that will lead to a material misstatement (including financial reporting) or regulatory reporting errors.

Definition—Data Integrity/Reporting Accuracy defines a level of confidence in the results, output or product of an IT asset.

Qualities that define reporting accuracy are:

Completeness: is the data whole or full representation including all necessary elements.

Correctness: conforms with the expected results of processing or transformations or maintains its original defining elements and characteristics.

Timeliness: is current within expected time periods.

Validity: is authorized or recognized as a trusted source.

A BARA questionnaire including guidance for each severity level for the data integrity/reporting accuracy risk category is shown in Table 4 below:

TABLE 4
Data integrity/reporting accuracy BARA questionnaire

| Data Integrity/Reporting Accuracy: | (Select One) | |
|---|---|---|
| If ‘Yes’ to any of the below questions continue | | |
| to rate the Financial Reporting and Data | | |
| Accuracy risk. | | |
| If ‘No’ Financial Reporting and Data Accuracy | | |
| risk may be rated as Insignificant. | | |
| Financial | | |
| Does any of the data contribute to the | | |
| Enterprise's Financial Statements? | | |
| Regulatory | | |
| Does any of the data contribute to any | | |
| Regulatory Reporting? | | |
| Strategic | | |
| Is any of the data relied upon to inform critical | | |
| business or strategic decisions? | | |
| If any part of the data is inaccurate or | | |
| unavailable, would it put your business (or | | |
| other businesses) at risk? | | |
| End User Computing (EUC) | | |
| Complexity | | |
| Business reliance | | |
| Data Integrity/Reporting Accuracy: | | Select |
| Utilize the general guidance in this section to | Risk | only those |
| rate the risk level. | Levels | that apply |
| General Guidance | | |
| Sox Relevant Applications | Extensive | |
| | (High) | |
| General Guidance (RCSA Scale) | | |
| Operational Impact | | |
| Business unit would be unable to deliver on | Extensive | |
| its mandate nor meet its objectives | (High) | |
| | Major | |
| | (High) | |
| Business unit would be able to substantially | Moderate | |
| deliver on its mandate & objectives. | (Medium) | |
| Business unit would be able to meet its | Minor | |
| mandate and objectives effectively. | (Medium) | |
| | Insignificant | |
| | (Low) | |
| Employee Impact | | |
| Loss of critical knowledge and skills that are | Extensive | |
| difficult to replace; low employee trust and | (High) | |
| engagement; threat of external intervention. | Major | |
| | (High) | |
| High turnover but skills and knowledge could | Moderate | |
| be replaced within a reasonable time period; | (Medium) | |
| low Pulse but concerns could be discussed | | |
| and addressed internally. | | |
| Acceptable turnover; reasonable pace of skill | Minor | |
| and knowledge replacement; open | (Medium) | |
| communication; good employee engagement. | Insignificant | |
| | (Low) | |
| Customer/Product Impact | | |
| High volume of customer complaints | Extensive | |
| requiring the involvement of senior | (High) | |
| executives & CAPA; service or product | Major | |
| related issues impact a significant number of | (High) | |
| clients, internal stakeholders, and/or “high | | |
| value” accounts; noticeable impact on sales; | | |
| product feedback negatively affects other | | |
| products, services, or channels | | |
| Repeated client complaints; service or | Moderate | |
| product related issues impact a moderate | (Medium) | |
| number of customers, internal stakeholders | | |
| and/or few “high value” accounts; some sales | | |
| objectives may be at risk; no other product, | | |
| service, or channel is affected | | |
| Small number of client complaints; service or | Minor | |
| product related issues impact a small number | (Medium) | |
| of clients and/or internal stakeholders; sales | Insignificant | |
| objectives not impacted; no other product or | (Low) | |
| service is affected. | | |
| Reputational Impact | | |
| Major/multiple stakeholder groups impacted; | Extensive | |
| national or global media coverage for >3 | (High) | |
| weeks | Major | |
| | (High) | |
| Limited number of stakeholder groups | Moderate | |
| impacted; limited media coverage (only | (Medium) | |
| state/province) for <3 weeks. | | |
| Limited/single stakeholder group impacted; | Minor | |
| one time issue; local media coverage. | (Medium) | |
| | Insignificant | |
| | (Low) | |
| Regulatory Compliance | | |
| Fines, penalties or sanctions that threaten | Extensive | |
| the ability to offer certain products or | (High) | |
| services; order to carry out corrective actions | Major | |
| that could have a high financial or | (High) | |
| reputational impact. | | |
| Regulatory action could involve a notice of | Moderate | |
| violation or an order to carry out some | (Medium) | |
| corrective actions; financial and reputational | | |
| impact of penalties/corrective actions may be | | |
| moderate. | | |
| No significant regulatory action is expected. | Minor | |
| | (Medium) | |
| | Insignificant | |
| | (Low) | |
| Regulatory Relations | | |
| Communications with government officials, | Extensive | |
| legislators and regulators may be | (High) | |
| predominantly one way and/or reactive, and | Major | |
| issue specific only; lack of collaboration, trust | (High) | |
| and transparency in relationship. | | |
| Communications with government officials, | Moderate | |
| legislators and regulators less consultative; | (Medium) | |
| communication may be more issue specific; | | |
| low to moderate degree of collaboration, | | |
| trust and transparency in relationship. | | |
| No significant impact to communication with | Minor | |
| government officials, legislators and | (Medium) | |
| regulators; no damage to trust or openness. | Insignificant | |
| | (Low) | |
| Financial Impact | | |
| Significant impact on the business unit's | Extensive | |
| revenue stream, losses, or income before | (High) | |
| tax; need to escalate and discuss at the | Major | |
| Segment Risk Committee level. | (High) | |
| Moderate but noticeable impact on the | Moderate | |
| business unit's revenue stream, losses or | (Medium) | |
| income before tax; need to escalate to | | |
| business senior executive(s). | | |
| Insignificant impact on the business unit's | Minor | |
| revenue stream, losses, or income before | (Medium) | |
| tax; no need to escalate beyond business | Insignificant | |
| unit management. | (Low) | |

The responses to BARA questionnaires may be used to automatically calculate or determine an expected risk rating relative to the impact scale. The automatic rating may be determined from the BARA questionnaire using a decision tree (not shown) or other automated process.

The automated rating may provide a bench mark and be compared to self assessed ratings provided by business owners. The comparison may drive further review and rationalization of the risk ratings. The business owner's risk rating may prevail over the calculated rating. The framework may be configured to receive and store supporting documentation of the risk rating justification for the variance.

At step 104, controls are selected and implemented. Controls may be defined as a measure incorporated into policies, standards and procedures, which are intended to prevent or to reduce the probability and/or the severity of a risk event. In some embodiments, controls may include anything that mitigates risk, thereby contributing to the likelihood that the business will achieve its objectives. Therefore, measures that reduce the probability and/or the severity of an operational event are managed by and expressed in policies, standards and procedures.

Technology control standards may be aligned with existing policies, regulatory requirements and current best practices. External authorities for the control standards may include various national, state or local authorities who have imposed requirements upon the enterprise. The authorities may include privacy related regimes, accounting and financial reporting regimes, and industry regulators (e.g. Federal Financial Institutions Examination Council (FFIEC) for financial institutions in the United States) and best practices organizations (e.g. Information technology—Security techniques—Code of practice for information security management published by the International Organization for Standardization (ISO) and the International Electrotechnical Commission (lED) as IST/IEC 27002 and Control Objectives for Information and Related Technology (COBIT) from the Information Systems Audit and Control Association (ISACA) such as COBIT 4.1).

To provide consistent controls the framework defines seventeen control areas as listed in Table 5 which are used to mitigate risks. These control areas are supported by the technology control standards. These standards may include individual statements which provide the details for fulfilling the control area requirements. Control statements are assigned to business applications based on the assessed risk. Any existing enterprise controls may be identified and aligned to control standard statements for uniformity.

Visibility for controls that are unsatisfied may provide a view into risk categories whose risks are not fully mitigated (residual risk).

Control review may be undertaken by business owners and/or framework team members and may include consultation with IT service providers for the business.

TABLE 5
Control Areas
Control Areas

| | |
|---|---|
| Access Management (AM) | Legal/Contractual (LE) |
| Awareness & Training (AT) | Logging & Monitoring (LM) |
| Availability Management (AV) | Privacy Assessment (PA) |
| Change/Config. Management (CM) | Physical Security (PS) |
| Control verification & Testing (CV) | Roles & Responsibilities (RO) |
| Document Management (DM) | SDLC (SC) |
| Encryption (EN) | System Defense (SD) |
| Fraud/Theft Management (FT) | 3rd Party Management (TP) |
| Incident Management & DR (IM) | |

A risk and control design matrix illustrates the association of the defined business risks, the impact and the additional/required control from the control catalogue. A risk and control design matrix may provide a risk based mapping of risk impact severity in each of the eight risk categories to the 17 control areas and identify if controls are required, additional or not required to mitigate the assessed risk.

Each risk area may develop a risk and control matrix specifically targeted to aligning control areas to their risk category for each level of risk. This provides a mechanism to consistently derive controls based on an assessed risk level.

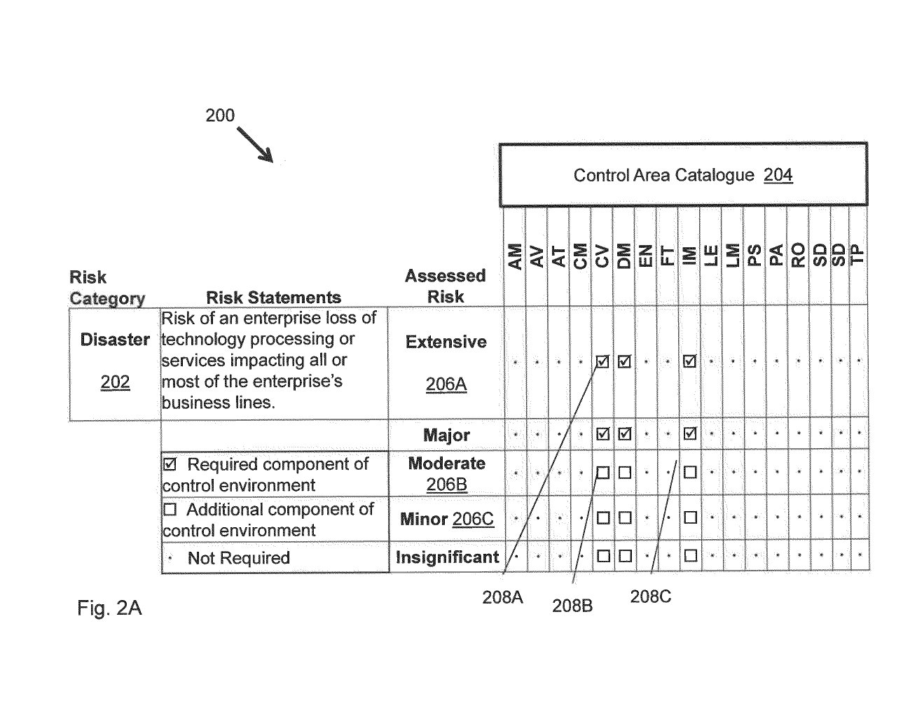

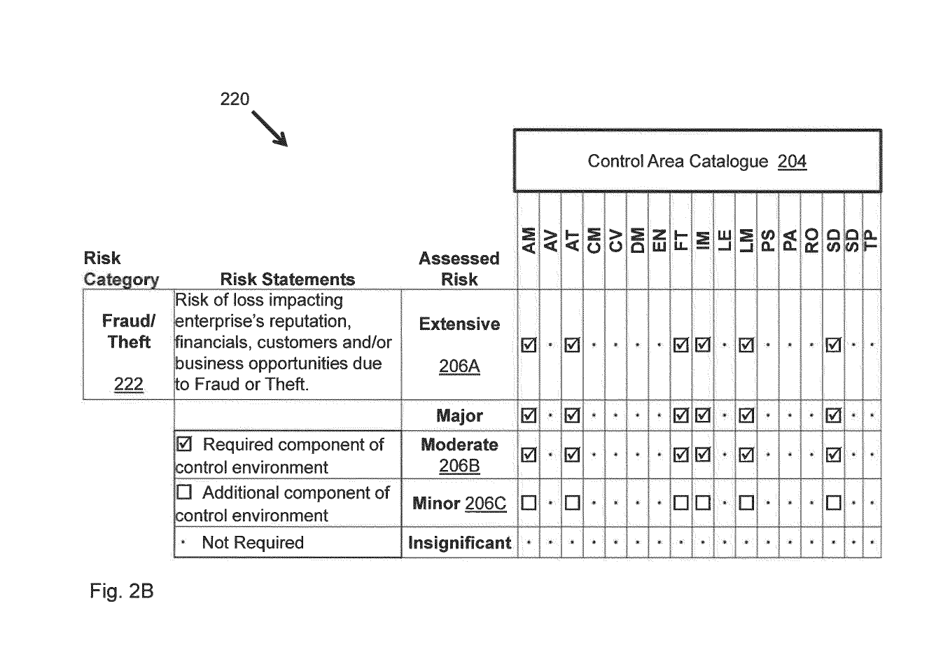

FIG. 2A illustrates an example of such a matrix 200 for the disaster risk category 202, in accordance with disclosed embodiments. The various control areas (see Table 5) of the control catalogue 204 indicate for a level of assessed risk (e.g. 206A, 206B, 206C) whether there is a required component of the control environment (e.g. 208A), an additional component (e.g. 208B) for example to provide an enhanced control framework that is above a baseline or standard, or no control required (e.g. 2080). FIG. 2B illustrates a matrix 220 for the fraud/theft risk category 222. A matrix may be derived for each risk category. A consolidated matrix may be derived from all of the individual matrices (not shown).

In step 106, operations verify and test the controls to ensure that mandatory controls are accurately implemented and effectively functioning. Testing procedures may be identified by type and frequency. Tests may be performed by internal personnel or a qualified 3rd party. A testing matrix may be used to determine type of testing and associated frequency as shown in Table 6.

TABLE 6
Testing Matrix

| Impact | | |
|---|---|---|
| (From Risk | Test | |
| Assessment) | Requirement | Frequency |
| Insignificant | Testing not required. | NA |
| Minor | Documented attestation of | Annual |
| | control environment | |
| | effectiveness for all controls | |
| Moderate | Documented attestation of | Annual |
| | control environment | |
| | effectiveness for recommended | |
| | controls and independent | |
| | validation of key controls | |
| Major | Independent validation of entire | Annual |
| | control environment or | |
| | evidence of other acceptable | |
| | testing (5970, etc.) | |
| Extensive | Independent validation of entire | Semi-Annual |
| | control environment or | |
| | evidence of other acceptable | |
| | testing (5970, etc.) | |

At step 108, monitoring and reporting may involve monitoring risk and security state of health across the enterprise by leveraging process tools and technology. Examples may include: Enterprise Security Manager, Intrusion Detection System, Anti Virus, Internal Audit and External Regulations Findings.

Dashboard reports may be created and produced to shows risks, decisions and action plans for remediation. For example, framework application 404 may be configured to calculate residual risk for each application (asset). A total inherent risk score for an application may be determined from the respective self-assessed risk levels. The impact scale may be mapped to numerical values, such as:

Extensive=1000

Major=500

Moderate=250

Minor=100

Insignificant=50

A sum of all of the assessed inherent risks for the asset may be computed. Residual risk for the application may be computed in accordance with the controls implemented for these risks. For example, a ratio or comparison of baseline control requirements and current control state (i.e. which controls are currently in place) may be computed. As noted previously, baseline control requirements may be associated with key controls to be implemented to moderate specific risks. Each specific key control may be associated with a risk reduction factor. For example, implementing a particular key control may reduce an extensive risk to a minor risk.

A “theoretical” total risk reduction score may be computed for the application on the assumption that all of the key controls are implemented. An actual total risk reduction score may be computed following a qualitative analysis that determines whether the key controls or an equivalent is actually implemented. Where the control or equivalent is not implemented, a gap exists and the inherent risk may remain. A ratio of the theoretical and actual total risk reduction score may be computed to give a key control compliance percentage. This percentage may be applied to the inherent risk score (i.e. multiplied with) to give a mitigation risk score for the application (how much was reduced). A residual risk score may be computed by subtracting from the inherent risk score the mitigation risk score. Inherent risk and residual risk may be compared to compute a residual risk ratio (%). As control implementation is progressed (changes made), new scores and ratios can be computed. Scores and ratios maybe compared period to period, etc.

Any of the inherent risk score, residual risk score, mitigation risk score, residual risk ratio, etc. may be applied to a scale to represent the respective score such as in a graph or other form. The scale may be a colour scale to visually indicate applications requiring additional controls, etc. For example, a residual risk ratio of <15% may be green, 15% to 20% may be yellow and >20% may be red such that:

Green—Actively managed controls within acceptable risk levels and issues that have arisen or may arise are considered manageable in the normal course;

Yellow—Issues have surfaced, which are considered manageable and are receiving appropriate business unit and/or senior management attention; and

Red—Serious issues have surfaced, which require extraordinary senior management attention.

Application scores may be rolled up (i.e. totaled) at the line of business and enterprise levels (e.g. for all applications in a particular line of business a total score or average ratio may be computed.)

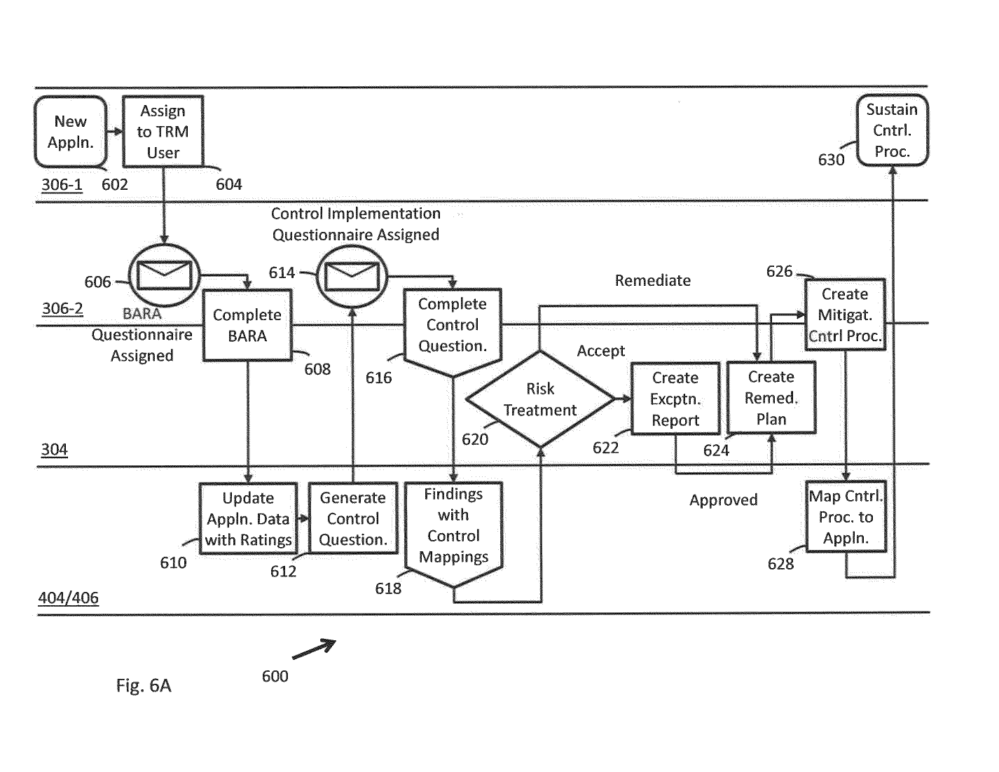

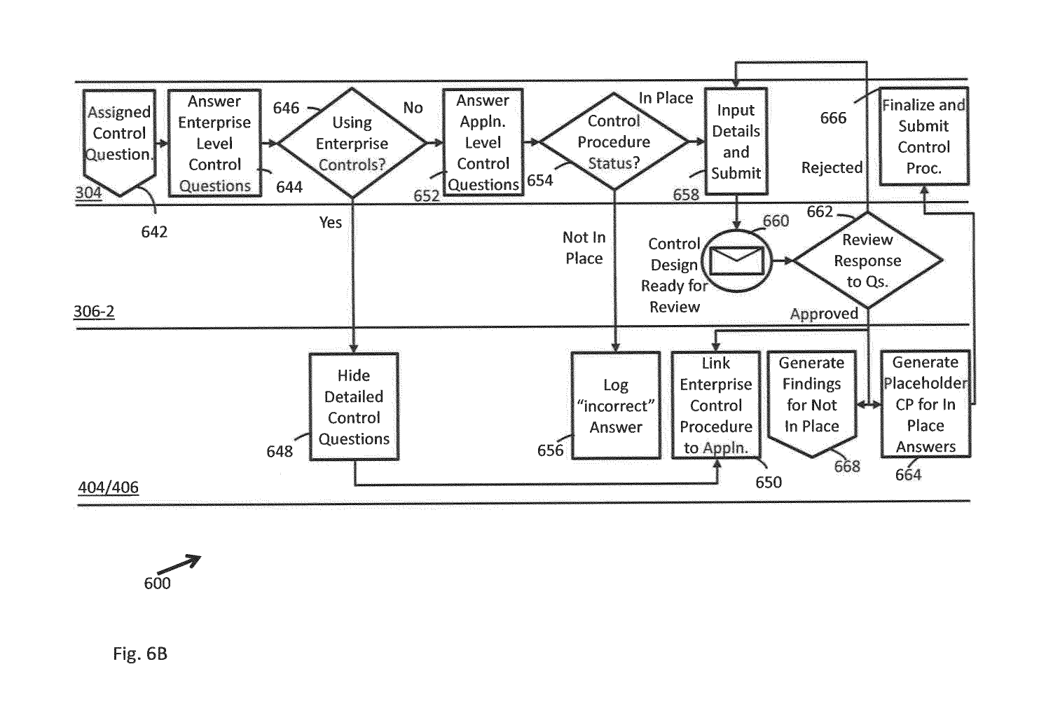

Operations for step 106 may involve framework team members working with business personnel and members of the IT team to self identify gaps (e.g. see FIG. 6B below). There may be framework team members with specific control and verification and testing duties who are tasked to identify gaps. Gaps may be identified through internal and external audits.

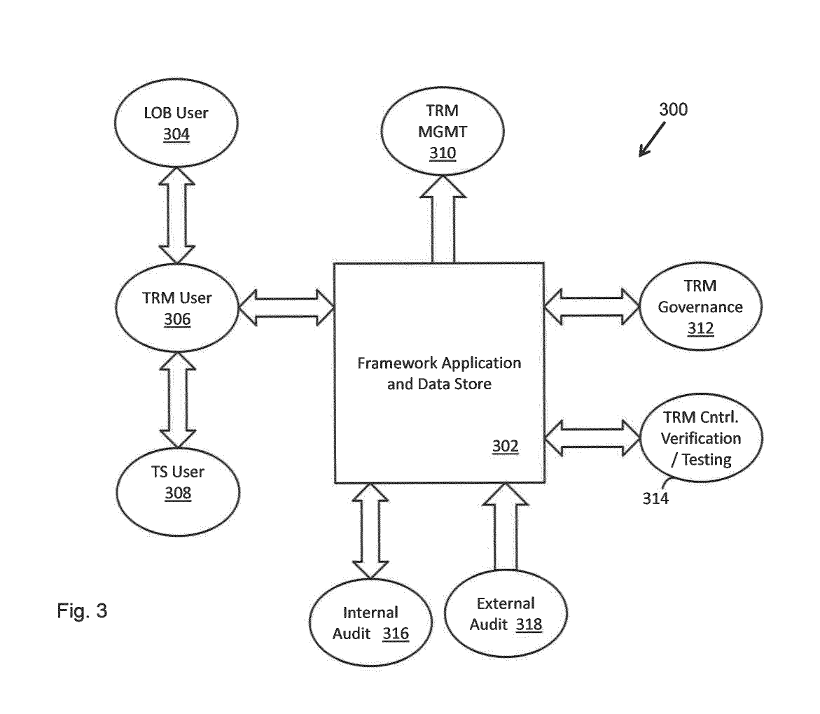

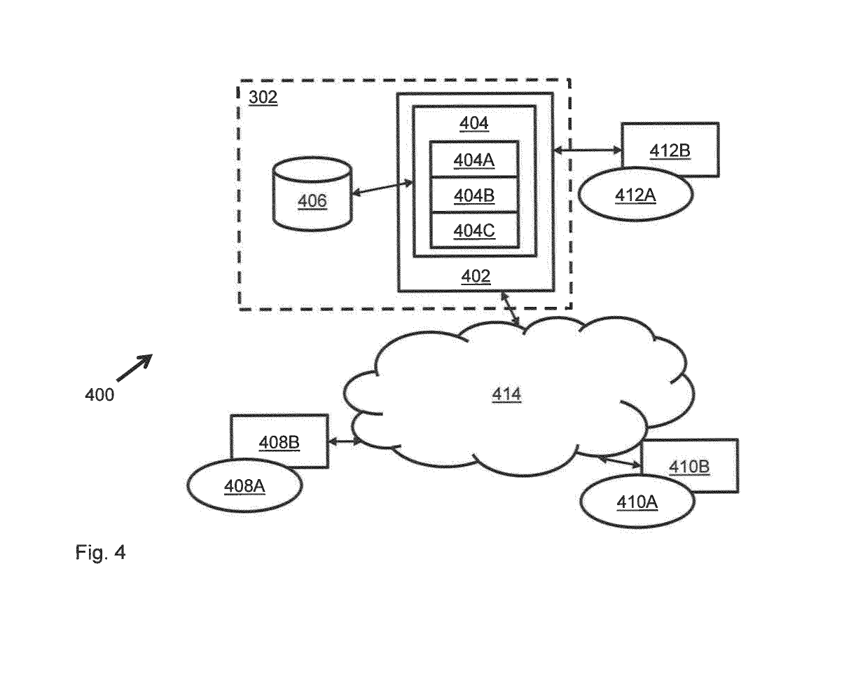

FIG. 3 illustrates a high level system context 300 implementing the framework and including interfaces and/or data shared among various actors who interact with the framework, in accordance with disclosed embodiments. There is shown a representative framework application and data store 302. It is understood that such may be implemented in a computer system such as one comprising at least one processor and tangible, non-transitory memory storing instructions executable by the processor and data configuring the processor to provide the framework via one or more interfaces. Framework application data such as user information, business application data, control data, risk assessments etc. may be maintained in a data store such as a relational or other database. Further details are shown in FIG. 4.

Framework application and data store 302 may be interacted with by various actors or users having various roles for performing technology risk and control management. In accordance with the example shown in FIG. 3, there are line of business (LOB) users (e.g. LOB User 304) having responsibility for the enterprise's business unit which “owns” the business application. There are technology risk management analysts (e.g., TRM User 306) with roles to perform risk assessment and control design for business applications. There are technology support teams (e.g., TS User 308) who have roles to support the business application for the LOB and who may have certain front line technical expertise and information to assist with risk and control issues. The users 304, 306 and 308 may collaborate, via the framework application and data store 302 to perform their risk and control duties, often via the TRM User 306. For example LOB User 304 may provide business risk assessment information for each of the risk areas. The TRM User 306 may inform the LOB User 304 and/or TS User 308 of certain compliance requirements and, together, the TRM User 306 and LOB User 304 users may complete the SARA and Control Design documents with assistance from the TS User 308. In some examples, the TRM user 306 may be the only user interacting directly with the framework application and data store 302, providing the business risk assessment and other data and receiving business risk ratings, control requirements, etc.

A TRM management (MGMT) User 310 may receive enterprise level reporting on risk and control issues. A TRM Governance User 312 may receive framework metrics and provide framework drivers and management oversight to the framework application and data store 302. A TRM control verification and testing User 314 may receive assessment procedures and provide assessment work, evidence and findings (results) to the framework application and data store 302.

Various audit interfaces may be provided, such as internal audit 316, to receive assessment results and to provide audit findings. Similarly, external audit 318 may provide audit findings to framework application and data store 302.

Though only single users of any user type (e.g. TRM User 306, LOB User 304) are illustrated, there may be more than one instance of each user type and it is understood that there may be teams of users and that some may have supervisory or other roles as further described below.

FIG. 4 illustrates a representative computing environment 400 comprising a framework application and data store 302, in accordance with disclosed embodiments. The environment may comprise a computer 402 having one or more processors (not shown) configured to execute an application 404 (e.g. software stored in a non-transitory manner to a tangible, non-transitory memory device or other storage device (neither shown)) having one or more modules implementing the framework. In one example, computer 402 may be configured as a server type computer. There may be provided a store for storing technology risk and control data (e.g., in a database 406 communicatively coupled to the processor of the computer 402 via a data interface (not shown)). Interface component 404A may provide user interfaces (e.g. graphical user interfaces (not shown)) to the users (e.g. 408A, 410A, 412A) of the computer 402. The interfaces may be presented via user computing devices (e.g. 408B, 410B, 412B) which may be coupled to framework application 404 (e.g., computer 402) and database 406 via one or more private and/or public and wired or wireless networks (e.g. a simplified network 414 is illustrated). The user interfaces may be configured to enable storing and accessing technology risk and control data as further described. It is understood that storing and accessing may include modifying, deleting, copying, pasting, importing, exporting, aggregating and analyzing, report running as well as other operations related to the data.

A workflow component 4048 may provide workflow to collaborative or other users to perform certain tasks within the framework, which tasks may involve storing and accessing technology risk and control data. Workflow may be used to present various user interfaces (such as may include screens/forms) to users to perform various tasks, to set schedules and track completion dates such as via workflow rules or other policies. Workflow rules or policies may be configurable such as by framework governance personnel or other users for example. The framework application may be configured to interface to other applications (not shown) such as email (e.g. to enable collaboration among users and track task status) or systems (not shown) such as a technology asset inventory system (e.g. providing a description of all business assets of the enterprise). A reporting component 404C provides management and other reports such as to identify tasks for completion and assess performance and compliance from the data of database 406. Other components will be apparent from the description of various operations.

In FIG. 4, a simplified environment 400 is shown without network components for example and a simplified computer 402 is shown without communication components, etc. It is understood that the users 408A, 410A, 412A are representative of any of users 304, 306, 308, 310, 312, 314, etc.

In one embodiment, computer 402 provides a web-based interface to at least some of the user computing devices 408B, 4108, 412E (e.g. desktops, laptops, tablets, smartphones or other user computing devices with processors and memories configurable with browser applications and communication capabilities, etc. for providing the web-based interfaces to the respective users 408A, 410A, 412A). Other implementations, such as native applications may be used.

Access to the framework application 404, database 406 and the user interfaces may be configured via policies or role-based access mechanisms whereby users 408A, 410A, 412A with different roles may receive access to different content, features or functions of the framework application 404. Framework team members (e.g., 304, 306 and 308) with roles to perform BARA and control design may have access to different content, features or functions of the framework application than members who perform management duties (e.g., 310), control verification and testing (e.g., 314) duties, and framework governance (e.g., 312) duties. Access may be provided for internal and external audit functions as noted.

Framework application 404 may be executed by computer 402 and may be configured to provide workflow and document/data management assistance to users 408A, 410A, and/or 412A, such as those who collaborate within the framework 100. Such collaborating users may include framework team members, line of business point of contact users and IT personnel providing support to the business applications and assets for performing BARA and control design operations within the framework.

The application 404 may be configured (e.g. via components 404A, 404B, 404C) to perform the standardization of the assessment and risk scoring process for both BARA and CD; creation of risk ratings for applications based on the BARA and CD assessment workflows; creation of gaps—or findings—from the CD assessment process and management of same; and the use of control procedures to mitigate gaps. The responses of users may be captured and stored to the database.

Attestation by appropriate users (e.g. by LOB users for BARA impact, etc.) may be captured and dated. Dates may be used to drive future events such as annual or other reviews. Data such as risk assessments may be exported to other systems (not shown). Data such as business application definitions can be imported from other systems.

Manual processes for risk assessment, control design, gap finding and remediation are resource intensive and difficult to manage. TRM personnel resources can spend a significant amount of time trying to manage the information with manual processes, increasing overall time and resources necessary to complete objectives. Organizing the risk assessment and control design processes in a consistent, centralized toolset allows personnel to focus more time on high value tasks.

Utilizing a consistent toolset also provides the added benefit of being able to provide more effective reporting and views into control information, reducing time and confusion in the TRM process and improves success rates.

Implementing a control framework in a centralized tool also allows for more effective expansion and maturing of the framework itself. A centralized tool facilitates numerous mapping and integration requests. Enterprise reporting allows framework metrics to be analyzed on a detailed level to provide decision making information for future efforts.

### General Workflow

The framework application 404 may be executed by computer 402 and may provide automated workflow processes and data management to implement the framework processes of FIGS. 1A and 1B. As noted above, certain events may trigger the updating or creation of new BARAs. Events include the addition of a business application to the enterprise's inventory (which inventory may be maintained in an application book of record (ABoR) (e.g., a computer implemented inventory system (not shown)), a project change impacts one or many new or existing business applications, so the risk impacts need to be verified and assessed (again), a “regular” (e.g., annual) attestation is required to see if the current risk ratings are correct.

Triggers for updating or creating new Control Designs include: when a BARA is updated and approved and the risk ratings have changed; when a change to the enterprises control standards may require a review and update of impacted Control Design(s); and when identified control gaps are remediated may require a review and update of impacted Control Design(s). In each of the above, the review and change process needs to be documented and changes logged through the framework application 404 to the database 406 for the respective affected business applications/assets.

New Applications

The framework application 404 may be executed by computer 402 and may be configured to receive data from external systems such as an ABoR inventory system. The receipt of data may define a triggering event to initiate the framework workflow process.

A new business application created in the ABoR can be signaled (communicated) to the framework application 404, for example, automatically or in response to user input to invoke the communication. The communication may provide new application data for defining a new application record in the database 406.

In another embodiment, the communication may comprise a notification to trigger the framework application 404 to query the ABoR inventory system for new application data. It is understood that the communication may relate to more than one new application in the ABoR such that the new application data adds more than one new application to the framework application 404/database 406 such as in a batch operation. In another example, a new business application may be defined via the framework application 404 directly to store in database 406 such as by inputting data to define same in the framework application 404 via a new application input interface (e.g. a form screen (not shown)).

Upon creation of a new business application, the framework application 404 may be configured to assign responsibility for the application to a particular user whose role it is to perform technology risk management duties (e.g. TRM user 306) such as preparing BARAs and CDs, etc. A TRM coordinator may perform such a task. As noted, other types of users of the framework application may include users from the line of business (LOB users) associated with the business application and/or information technology support personnel (TS users) associated with the business application; framework application administrator users (Admin users); management users (MGMT users); etc. Users within a particular type may have different roles. For example, there may be primary point of contact users within an LOB or TS area whose role is to carry most of the task and approvers who are charged with ultimate review and signing off/validation on completion/attestation.

The association between a particular business application and a TRM user may be stored in the database 406. The framework application 404 may be configured to store various data in association with each particular business application including respective BARAs, CDs, Control Gaps, attestations, etc. The database 406 may further be configured to store a history of such information (e.g. revisions) and a full audit trail (e.g. data showing users interacting with the information (user names/IDS), in what manner (e.g. create/access/edit/export/print, etc.), and when (date/time)). Associations may also be made and stored for LOB users 304, TS users 308, etc.

The framework application 404 may be configured to provide various views (not shown) of the data in the database 406 such as a user portfolio view in an interface showing business applications assigned to a particular user. The portfolio view may be configured to show a list of business applications. The view may be configured to enable a user to drill down to more data for a specific business application (e.g. by clicking/touching on the particular application in a list of applications or via a menu, etc.).

The definition of a new business application in the framework application 404 may automatically trigger various workflow processes. For example, tasks (e.g., to initiate preparation of a BARA) for a particular business application may be assigned to the TRM user 306 associated with the business application. As the TRM user 306 or other user (e.g., user 304) interacts with the framework application 404 to perform the tasks, the framework application 404 tracks performance (e.g., stores logs of activities to the database 406) and can update task status (e.g. to show task assigned, task started, task awaiting particular response from another user, task completed, etc.) More granular task status may be maintained, for example, tracking whether particular notifications (emails) are sent, whether such have been auctioned by the recipient, reminders, etc.

The framework application 404 may be configured to permit a TRM user 306 or other user to assign or otherwise notify other users of tasks. For example, a TRM user 306 may collaborate with LOB users 304 or TS users 308 to perform a task such as completing a BARA for the business application.

The framework application 404 may be configured to send messages such as email to a user (e.g. user 304, 306, etc.) to notify the user of a new task or notify a reminder about an outstanding task.

The framework application 404 may be configured to receive and store data such as electronic documents (e.g., emails, imported documents (in an image or other format), etc.) to log in database 406 in association with task performance or other data for a business application.

The database 406 may be searchable (e.g. via the framework application 404) to retrieve business applications and/or associated information (e.g. a particular BARA for a particular application). The portfolio view may be configured to show outstanding tasks for a particular application or all applications in a user's portfolio.

Project Changes

TRM Users 306 may be assigned to projects such as those in which business applications or other assets are undergoing project changes. Once it is known what business applications could be impacted by the project changes, a TRM User 306 may “check out” a BARA (or Control Design) from database 406 and initiate a review. The TRM User 306 is assigned to the outstanding task. Version control assists when a business application is being modified. Users (e.g., users 304, 306, 308, etc.) are able to view current risk ratings for the business application in database 406 as well as ratings that are about to be released into production. A complete history of changes may be maintained through (automatic) versioning of the data in the database 406.

Attestations

The framework application 404 may be executed by computer 402 and may be configured to trigger regular reviews of particular or all BARAs. For example, operations may be configured that annually all BARAs need to be attested by the line of business in the enterprise. The workflow for this may vary from business to business. Initially, a report that identifies BARAs that need to be attested within the next XX days (e.g. 60 days) may be generated and tasks assigned. TRM users 306 assigned to specific applications (e.g. in the TRM users portfolio) are alerted that an attestation task is pending. The task may be re-assigned to another TRM user 306. It may be desired that the ability to reassign should only be permissible by TRM users 306 who are associated to the same line of business. The TRM user 306 may collaborate with a member of the LOB such as an LOB user 304 to complete the attestation. The task may include uploading (storing) attestation documents from the LOB. In some examples, the framework application 404 may be configured to capture an electronic attestation by the LOB e.g. through a user interface where the LOB user 304 confirms the attestation. Notes or other supporting data may be input and saved.

The framework application 404 may enable TRM users 306 and/or LOB users 304 to review all existing application contact information (technology and business contacts) and determine if this information is correct and make any necessary updates that will be used by the workflow process.

The framework application 404 may enable the LOB user 304/TRM user 306 to designate the people (users) that are needed to review and update a BARA and whether the TRM user 306 needs to insert themselves in between multiple people. Once a BARA is updated/saved to database 406 and then submitted, it is transferred to the next person in the queue. There is always a LOB person that is designated to update the BARA and a person who has ultimate LOB validation rights.

The workflow process executed by computer 402 may be flexible and permit the TRM user 306 to configure various orders of particular operations. For example, the TRM user 306 may identify the first (next) user in the queue that should review a BARA (which could be a TS user 308 or a LOB user 304). A notification (email) is then sent to that user (304 or 306) once the TRIM user 306 changes the BARA status to do so. The TRM user 306 may have the ability to book a meeting with the BARA document contributors (e.g. 304 or 306) before framework application 404 generated notifications are sent.

Examples of workflow options among TRM, LOB and TS personnel are:

TRM Consultant>Technology Contact>TRM Consultant>Business Contact>Business Approver>TRM Consultant

TRM Consultant>Business Contact>Business Approver>TRM Consultant

Business Contact>Business Approver

Some businesses may have several people that will review and attest.

The framework application 404 may enable TRM users 306 to view a list of their ‘portfolio’ applications and the stages in the workflow of each. For example, through granular status tracking in the workflow processes of framework application 404 and data of database 406, the framework application 404 may enable TRM users 306 to view that they have yet to send an email notification, or if a notification has been sent, but not actioned yet. Once the receiving user starts to make changes and saves them, the TRM user 306 is able to see the change in status.

The enterprise may have personnel (e.g., governance personnel (312)) who are responsible to maintain the overall framework implemented by the framework application 404. The framework application 404 may be configurable or otherwise adaptable to framework changes. For example, framework administrative users (e.g. TRM Governance users 312) may be provided with an interface (not shown) to configure conditions for an attestation for a particular business application. In one example, the line of business may simply be required to review current risk ratings for each of their business applications and attest that they are still correct. The business name and attestation date can be recorded along with comments. If there are any significant changes in any of the risk categories, the business may be required to review these changes first, answer any new questions and submit their updated risk ratings. Once the technology or business person has finished making all necessary changes, they should submit the updated BARA. A TRM user 306 may then be alerted that there is a task that needs to be reviewed. The TRM user 306 may choose to send it back to the same person with comments seeking clarifications or changes or the TRM user 306 may choose to send it to another person in the workflow “chain.” The framework application 404 may be configured to provide the TRM user 306 to add personal comments when sending a task to another.

The framework application 404 may be configured with various predefined data views (e.g. user dashboards and portfolio views) and reporting abilities to enable users to perform advance analysis, among other tasks. Report generation may be automatic (e.g. daily, weekly etc.) or invoked on demand.

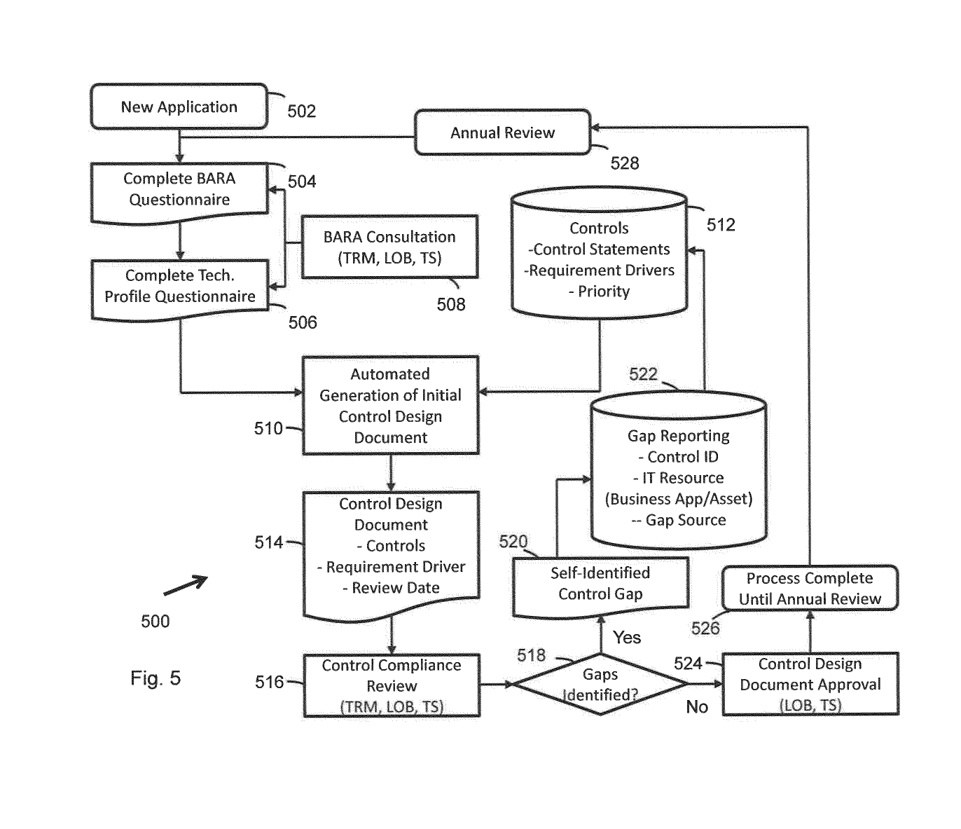

FIG. 5 is a block diagram of an overview of the workflow 500 including documents/data generated, in accordance with disclosed embodiments. In some aspects, workflow 500 may be executed by the one or more processors of computer 402. At 502, a new application is defined in the framework application 404. The new application triggers workflow to initiate the generation of a BARA. At step 504, a BARA questionnaire is completed such as by LOB users 304 and a Technology Profile questionnaire is completed such as by TS personnel 308.

At 508, collaboration between TRM user 306, LOB user 304 and TS user 308 is generally illustrated to complete steps 504 and 506. The BARA may be logged in database 406 in association with the business application (not shown). At 510, using the BARA answers and a store of controls (512) from database 406, the framework application 404 automatically generates an initial Control Design document 514. The framework application 404 may select appropriate control statements such as by mapping or evaluating appropriate flags in the control store 512 (in database 406) as being applicable to the risk assessments. The control store 512 may comprise control statements, associated requirement drivers for the statements (e.g. the identification of specific enterprise policies, external regulatory or best practice requirements, etc.) and a priority indicator.

At step 516, a control compliance review may be performed by one or more users (e.g. users 304, 306, 308) such as in collaboration to determine whether any control gaps exist in relation to the business application under review. If gaps are self-identified, via Yes branch at 518, a report is made (e.g., in step 520) and the report is logged (e.g., in step 522) to initiate gap reporting. The specific control is identified along with the IT resource (application/system) and the gap.

If gaps are not identified, via No branch at 518, the control design document is approved (e.g., in step 524) and logged in database 406. The workflow process is complete (e.g., in step 526) until annual review is initiated (e.g., step 528) to re-do the process 500. Other triggers such as project changes occurring before the annual event trigger could initiate an earlier review (not shown).

FIGS. 6A and 6B provide more detailed overview of BARA, Control Design and Gap Identification workflow 600 in accordance with one example. In some aspects, workflow 600 may be executed by the one or more processors of computer 402. Various operations and outputs, etc. are shown in association with actors in the workflow, such as a TRM coordinator 3061, a TRM analyst 3062, a LOB App owner 304 and the framework application/database 404/406. The workflow is simplified and not all of the operations of framework application 404 or database 406 are illustrated for example.

At 602, the new application created in the framework application may trigger new activity for the TRM coordinator 306-1. Though not shown, the new application may be created following receipt of data from an external ABoR system. The TRM coordinator 306-1 may assign the application to a TRM analyst 306-2 at step 604. At step 606, the TRM analyst 306-2 receives notification (e.g. via email) of the assignment. The TRM analyst 306-2 in collaboration with one or more others (e.g. LOB and TS personnel/users represented as step 304) completes and submits the SARA questionnaire 608. At step 610, the framework application 404 may update the application record in database 406 with risk ratings for the business application from the BARA including any external system updates (e.g. export data for) such as for the ABoR inventory system.

At step 612, a control implementation questionnaire is generated to drive completion of the control document and gap identification. At step 614, the TRM analyst 306-2 receives notification (e.g. via email) of the task to complete the questionnaire. At step 616, the questionnaire is completed and submitted to the framework application 404 (and logged in database 406 (not shown)). Further details are discussed with reference to FIG. 6B below.

The framework application 404 may generate findings with control standard mappings at step 618. At step 620, the findings undergo risk treatment where control gaps are reviewed for further action/follow-up such as by LOB, TS and TRM personnel. Via “accept” branch at step 620, an exception request may be made (622) for a particular control and approval is determined before transitioning to next steps. If an exception is not sought (e.g., via “remediate” branch at step 620) or if received, a remediation plan is generated (e.g., in step 624) to work to close the control gap. Approval is conditioned on moving forward. At step 626, mitigating control procedures are created (defined) and at step 628 stored in the framework application 404 and database 406 in association with the business application.

FIG. 6B shows a more detailed overview of operations 600 related to steps 616 and 618 of FIG. 6A. At step 640, the LOB User 304 may be assigned a control design questionnaire to drive control design and evaluation for the business application. The questionnaire may be designed to elicit responses about controls that are in place and where controls are not in place. Where the controls are in place, the questionnaire assists to determine if the controls align explicitly with enterprise policies, etc. and where they not so aligned but may be acceptable at least in the short term. At step 644, enterprise level control questions are answered to determine alignment at step 646. If all the controls align, via “Yes” branch to step 648, further questions may be hidden and, at step 650, the specific enterprise control procedures are linked to the business application in the data store/framework application. No control gaps exist.

If the implemented controls are not all in alignment, for example, because a control for a specific risk is missing (e.g., “not in place”) or because at least one control is application specific and not in alignment with the control required by the enterprise policy, etc., via “No” branch to step 652, application level control questions are posed and responded to. At step 654, control procedure status is determined indicating whether the control is “Not in place” or “In place” and operations branch accordingly. If it is determined that a control is “Not in place”, the “incorrect” answer/lack of control is logged (e.g., at step 656) in database 406. A gap exists. If some control is “In place”, further details are elicited and a response submitted for review (e.g., at step 658). At step 660, the review activity for the control design is assigned to a TRM analyst 306-2. At step 662, a determination concerning the description of the application specific control is made. If the information submitted is “Rejected”, the matter (i.e. operations) may be returned to the LOB user 304 for further information and re-submission. If the submission is approved at step 662, operations continue via the “Approved” branch. The framework application may review the responses and take various actions. At step 664 the framework application 404 generates a placeholder control procedure for application specific controls that are in place, and refers the control procedure/control design document response for final approval and submission by the LOB user 304 at step 666. At step 650, any implemented enterprise level control procedures are linked to the business application in database 406. As mentioned previously, linking of specific enterprise level control procedures to the business application assists to identify all of the business applications that are affected by a specific control procedure. Should that control procedure be changed (e.g. in response to regulatory or other demands, enterprise policy, best practices, etc.) respective business applications may be identified and BABA and/or Control Design review triggered and/or other steps can be undertaken. At step 668, findings for “not in place” controls are generated for further risk treatment review/remediation described with reference to operations step 620 and following of FIG. 6A.

The framework and database may provide standardization of TRM workflows and assessment methodologies for the enterprise so that business applications across more than one line of business may be assessed in a uniform and rigorous manner. The workflows enable collaboration among various users when performing task such as to prepare a SARA and attest to same, to prepare and document controls for such identified risks and to identify gaps in such controls. Various granularities of task status data may be maintained about the progress of tasks to monitor and drive performance.

The framework and database may provide better correlation of risk data from diverse sources such as assessments, incidents, vulnerabilities, and threats. The data collected and the framework interfaces thereto may enable more timely availability of information on risk and greater confidence in risk-related information and profiles from such activities. In some examples, risks associated at the application level may be reviewed and reports may be prepared at various portfolio levels. The state of controls may be reported.

In some examples, risk and/or control data may be provided from the framework application and database to external systems such as an application inventory system.

1. A computer for collaborative technology risk management, comprising:
a database to store technology risk and control data for a plurality of business assets utilized by an enterprise; and
a processor and tangible, non-transitory memory storing instructions for configuring operations of the computer to provide:
user interfaces to store and access the technology risk and control data; and
workflow for collaboratively performing tasks by a plurality of collaborating users to perform the technology risk management; and wherein the workflow and user interfaces are configured to;
assess business asset risk for a particular business asset;
perform control design to identify controls for the particular business asset in response to the business asset risk; and
indentify and manage control gaps where controls for the particular business asset are not in place.

2. The computer of claim 1, wherein the plurality of collaborative users comprise one or more of:
line of business (LOB) users representing the line of business utilizing the business asset in the enterprise;
technology risk management users representing risk management personnel responsible to assess and mange risk; and
technology support users representing technology personnel supporting the business asset for the LOB.

3. The computer of claim 1, wherein the workflow and user interfaces are configured to communicate task information among the plurality of collaborative users to notify respective collaborative users of tasks to be performed.

4. The computer of claim 1, wherein the workflow and user interfaces are configured to automatically track performance of respective tasks by respective collaborative users and store task performance data to the database thereby to track and manage completion of the tasks.

5. The computer of claim 1, wherein the workflow and user interfaces facilitate an automated risk assessment for completion by at least some of the plurality of collaborative users to assess risk for a particular business asset in accordance with a plurality of risk categories.

6. The computer of claim 5, wherein the workflow and user interfaces receive and store an attestation of the business asset risk assessed by the automated risk assessment, the attestation provided by a line of business (LOB) personnel member representing the line of business utilizing the business asset in the enterprise.

7. The computer of claim 5, wherein the automated risk assessment generates the business asset risk comprising a level of risk for each of the risk categories in accordance with a standardized impact scale and wherein the level of risk is stored to the database in association with the business asset.

8. The computer of claim 5, wherein the technology risk and control data comprises technology control standards comprising consistent controls used to mitigate risks in a plurality of control areas; and wherein respective controls from each of the control areas are automatically assigned to the particular business asset in accordance with the business asset risk as assessed.

9. The computer of claim 8, wherein the technology control standards comprising the consistent controls are stored in association with respective requirement drivers to identify at least one source providing a requirement for a respective control thereby to facilitate a determination of which particular business assets are impacted by which requirements.

10. The computer of claim 1, wherein the workflow and user interfaces facilitate an automated control compliance review for completion by at least some of the plurality of collaborative users to identify whether the respective controls assigned in accordance with the business asset risk are actually in place for a particular business asset, the workflow and user interfaces storing findings data representing results of the control compliance review.

11. The computer of claim 10, wherein the workflow and user interfaces receive findings data about application level controls which are in place but which differ from the respective controls assigned in accordance with the business asset risk to further identify compliance or control gaps.

12. The computer of claim 1, wherein the workflow automatically, on a periodic basis, assigns tasks in association with a business asset to re-perform the technology risk management.

13. A computer-implemented method to collaboratively perform technology risk management, comprising:
storing and providing access to technology risk and control data via user interfaces to a computer, the technology risk and control data being maintained in a database communicatively coupled to the computer and the technology risk and control data providing information for a plurality of business assets utilized by an enterprise; and
providing workflow for collaboratively performing tasks by a plurality of collaborating users to complete the technology risk management; and
wherein the workflow and user interlaces are configured to:
assess business asset risk for a particular business asset;
perform control design to identify controls for the particular business asset in response to the business asset risk; and
indentify and manage control gaps where con or the particular business asset are not in place.

14. The computer-implemented method of claim 13, wherein the plurality of collaborative users comprise one or more of:
line of business (LOB) users representing the line of business utilizing the business asset in the enterprise;
technology risk management users representing risk management personnel responsible to assess and mange risk; and
technology support users representing technology personnel supporting the business asset for the LOB.

15. The computer-implemented method of claim 13, wherein the workflow and user interfaces are configured to communicate task information among the plurality of collaborative users to notify respective collaborative users of tasks to be performed.

16. The computer-implemented method of claim 13, wherein the workflow and user interfaces are configured to automatically track performance of respective tasks by respective collaborative users and store task performance data to the database thereby to track and manage completion of the tasks.

17. The computer-implemented method of claim 13, wherein the workflow and user interfaces facilitate an automated risk assessment for completion by at least some of the plurality of collaborative users to assess risk for a particular business asset in accordance with a plurality of risk categories.

18. The computer-implemented method of claim 17, wherein the workflow and user interfaces receive and store an attestation of the business asset risk assessed by the automated risk assessment, the attestation provided by a line of business (LOB) personnel member representing the line of business utilizing the business asset in the enterprise.

19. The computer-implemented method of claim 17, wherein the automated risk assessment generates the business asset risk comprising a level of risk for each of the risk categories in accordance with a standardized impact scale and wherein the level of risk is stored to the database in association with the business asset.

20. The computer-implemented method of claim 1, wherein the technology risk and control data comprises technology control standards comprising consistent controls used to mitigate risks in a plurality of control areas; and wherein respective controls from each of the control areas are automatically assigned to the particular business asset in accordance with the business asset risk as assessed.

21. The computer-implemented method of claim 20, wherein the technology control standards comprising the consistent controls are stored in association with respective requirement drivers to identify at least one source providing a requirement for a respective control thereby to facilitate a determination of which particular business assets are impacted by which requirements.

22. The computer-implemented method of claim 13, wherein the workflow and user interfaces facilitate an automated control compliance review for completion by at least some of the plurality of collaborative users to identify whether the respective controls assigned in accordance with the business asset risk are actually in place for a particular business asset, the workflow and user interfaces storing findings data representing results of the control compliance review.

23. The computer-implemented method of claim 22, wherein the workflow and user interfaces receive findings data about application level controls which are in place but which differ from the respective controls assigned in accordance with the business asset risk to further identify compliance or control gaps.

24. The computer-implemented method of claim 13, wherein the workflow automatically, on a periodic basis, assigns tasks in association with a business asset to re-perform the technology risk management.
